(19) United States
(12) Patent Application Publication
(10) Pub. No.: US 2026/0329720 A1
(43) Pub. Date: Oct. 22, 2026

(54) AUTOMATED RELEASE NOTE GENERATION

(71) Applicant: DISH Wireless L.L.C., Englewood, CO (US)

(72) Inventor: Eran Eldar, Highlands Ranch, CO (US)

(21) Appl. No.: 19/184,379

(22) Filed: Apr. 21, 2025

(51) Int. Cl. G06F 11/3604; G06F 8/73

(52) U.S. Cl. CPC G06F 11/3608; G06F 8/73

(57) ABSTRACT

A pull request for a modified source code is initiated. A user requirement identifier associated with the modified source code is identified responsive to completion of the pull request. A user requirement is obtained using the user requirement identifier. A code difference for the modified source code is obtained based on the modified source code. A prompt based at least in part on the user requirement and the code difference to generate a release note for the modified source code is processed using an artificial intelligence (AI) model.

### BACKGROUND

Software development has evolved from waterfall methodologies to more agile and iterative approaches. Modern software development follows a process with multiple stages that transform user requirements into functioning source code for end users. The software development lifecycle begins with identifying and documenting a user requirement. This user requirement captures a specific function or feature needed by the end user and is stored in a user requirements repository such as Jira, Rally, or Azure DevOps, where the user requirement receives a unique identifier for tracking.

A developer assigned to implement the user requirement creates a branch in a source code repository using a version control system like the distributed version control system called Git. The branch serves as a separate workspace for modifying the source code without affecting the main branch of the source code repository. Typically, the branch is named using a convention that includes the user requirement identifier. The developer modifies the source code to implement the functionality described in the user requirement. As the developer completes discrete units of work, the developer creates commits in the source code repository. Each commit includes a message describing the purpose of the change and references the user requirement identifier.

Upon completing implementation, the developer initiates a code review by creating a pull request. The pull request is a proposal to merge the modified source code into the main branch of the source code repository. Typically, the pull request includes metadata linking the pull request to the original user requirement. Team members review the code changes within the pull request, providing feedback and suggesting improvements. The developer addresses these comments by making additional commits to the branch as needed. Once approved, the pull request is merged into the main branch of the source code repository.

The merge updates the user requirement status in the user requirements repository to indicate implementation, creating a trail of traceability from the original user requirement to the specific code changes made to implement it. Upon successful merging, a release note is generated. Traditional approaches to release note generation have been largely manual, with product managers or technical writers reviewing completed work and drafting documentation. This process can be time-consuming and sometimes results in inconsistent documentation.

### BRIEF DESCRIPTION OF THE DRAWINGS

The present disclosure is illustrated by way of example, and not by way of limitation, in the figures of the accompanying drawings.

FIG. 1 is a block diagram of a software development system according to at least one embodiment.

FIG. 2 is an exemplary release management workflow of the software development system of FIG. 1 according to at least one embodiment.

FIG. 3 is a flow diagram of an example method of automated release note generation according to at least one embodiment.

FIG. 4 illustrates an example machine of a computer system according to at least one embodiment.

### DETAILED DESCRIPTION

Aspects and embodiments of the present disclosure address the above and other deficiencies by automating release note generation. In particular, upon successful merging in response to a pull request, a unique identifier of the user requirement (e.g., user requirement identifier) is identified for use in retrieval of a corresponding user requirement. As previously described, the user requirement identifier may be retrieved by extracting it from version control metadata such as branch names, commit messages, and pull request details that reference the user requirement. Once the user requirement identifier is identified, the user requirement identifier is used to retrieve the corresponding user requirement from the user requirements repository. In particular, the user requirements repository is queried using the user requirement identifier for the corresponding user requirement.

After retrieval of the corresponding user requirement, a code diff is generated from the modified source code, which shows the difference between the source code and the modified source code. The code diff highlights additions, deletions, or modifications between the source code and the modified source code. An input request (e.g., a prompt) is generated based on the corresponding user requirement and the code diff for the modified source code associated with the corresponding user requirement for a large language model (LLM) to process. The LLM processes the input request and provides, from the modified source code, a release note. The release note highlights how the modified source code implemented changes that meet a corresponding user requirement, such as resolving an issue, adding requested features, or improving functionality.

Advantages of the present disclosure include, but are not limited to, automating release note generation, thereby reducing manual documentation labor, and minimizing human error to create more consistent software update communications.

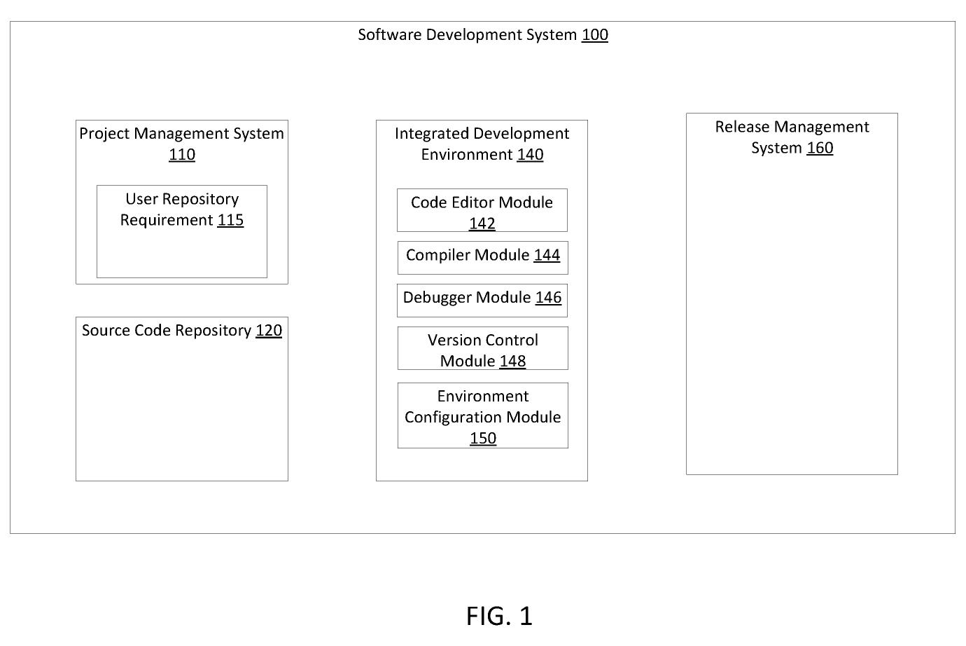

FIG. 1 illustrates a software development system 100. The software development system 100 includes a project management system 110, a source code repository 120, an integrated development environment 140, and a release management system 160.

The project management system 110 coordinates software development by tracking user requirements and facilitating stakeholder communication. The system generates a unique user requirement identifier for each user requirement. The user requirements repository 115 captures each user requirement as a discrete, structured element of project scope. Each user requirement possesses a specific status that tracks its progression through the development lifecycle, with common statuses including draft, approved, in progress, under review, completed, and rejected.

The user requirements repository 115 generates a unique user requirement identifier for each user requirement. User requirements, such as those implemented in Jira and/or Rally, can include the unique user requirement identifier, a title, a detailed description, an acceptance criteria, a priority level, a current status, an estimated effort, an assignee, labels, attachments, comments, epic or parent relationship, sprint/iteration information, and a user requirement creator. The unique user requirement identifier provides a trackable reference. The title offers a concise summary of the user requirement. The description explains a user need. The acceptance criteria define completion conditions. The priority indicates importance of the user requirement. The status tracks progress of the user requirement. The estimated effort quantifies complexity of the user requirement. The assignee specifies responsibility of the user requirement. The labels categorize the requirement of the user requirement. The attachments provide supporting documentation for the user requirement. The comments capture discussion of the user requirement. The epic links to broader context of the user requirement. The sprint shows development cycle of the user requirement. The reporter identifies the origin of the user requirement. The project management system 110 enables stakeholders to transform complex project objectives into manageable, traceable user requirements, facilitating clear communication of development goals throughout the software development lifecycle.

The source code repository 120 stores and maintains source code, for example network functions of a cellular network, along with its complete revision history. The source code repository 120 provides access to any previous state of the codebase through a hierarchical file organization structure. The source code repository 120 records changes to source code as commits, each containing metadata such as author information, timestamps, and descriptive messages. The source code repository 120 organizes these commits in a directed acyclic graph (DAG) representation, establishing relationships between different versions of the code. The source code repository 120 supports branch management for parallel development workflows. The source code repository 120 implements branches as references to specific commits, allowing developers to work independently on separate features or fixes (e.g., of network functions). The source code repository 120 tracks these branch references and updates them when new commits are added to the revision history. When combining code from different branches, the source code repository 120 executes integration operations. Integration operations within the source code repository 120 include creating merge commits that join multiple development paths, performing fast-forward operations that update references without creating additional commits, and identifying conflicting modifications in code segments changed differently across branches.

For example, the network functions in a cellular network, such as a 5G cellular network, serve as the building blocks that enable wireless communication services. The 5G cellular network may be a wireless telecommunications system that connects user equipment (mobile phones, IoT devices) to the internet and other networks through radio signals transmitted between base stations and mobile devices. Network functions represent discrete software components that perform specific tasks within this cellular infrastructure. The network functions can be deployed as virtualized software instances running on standardized hardware or cloud infrastructure rather than proprietary equipment. In the 5G architecture, the network functions are modularized and implemented using modern software development practices, with functions like packet processing (UPF), mobility management (AMF), and session management (SMF) developed and maintained as separate codebases. Using the software development system 100, developers can create branches for implementing specific features or fixing issues in these network functions, track requirements through unique identifiers, and integrate changes through merge operations when development is complete, ensuring the cellular network's services remain robust and scalable.

The integrated development environment 140 provides a comprehensive software application for creating, modifying, testing, and managing code (e.g., of network functions) throughout the development lifecycle. The integrated development environment 140 integrates multiple development modules including a code editor module 142, a compiler module 144, a debugger module 146, a version control module 148, and an environment configuration module 150 within a unified interface.

The code editor module 142 enables developers to create and modify source code (e.g., of network functions of cellular networks) with enhanced productivity features via tools for efficient code creation, modification, and navigation within project files. The compiler module 144 transforms source code into executable program code by performing necessary operations to convert human-readable source code into machine-executable instructions (e.g., for network functions of cellular networks). The debugger module 146 assists developers in identifying and resolving errors in program execution. The debugger module 146 enables developers to monitor and control program execution for testing and troubleshooting purposes (e.g., of network functions of cellular networks).

The version control module 148 interfaces with a source code repository 130 to track and manage changes to source code. The version control module 148 creates versions of source code, tracks changes between versions, and maintains relationships between different development branches (e.g., for network functions of cellular networks). In some embodiments, the version control module 148 supports branch-based development workflows where developers create separate workspaces (branches) for implementing specific features or fixing particular issues (e.g., in network functions of cellular networks) without affecting the main codebase.

The version control module 148 manages branch operations including creation, tracking, and merging. When a developer needs to implement a user requirement (e.g., for network functions of cellular networks), the version control module 148 can create a branch with naming conventions that reference the requirement's unique identifier. As development progresses, the version control module 148 records discrete changes (commits) with descriptive messages and identifier references. When implementation is complete, the version control module 148 facilitates code integration through merge operations that combine changes from development branches into main branches while detecting and resolving conflicts.

The environment configuration module 150 manages the development workspace and project settings (e.g., for network functions of cellular networks). The environment configuration module 150 handles project dependencies, execution environments, and build configurations. In some embodiments, the environment configuration module 150 supports various development workflows across different project types (e.g., including network functions of cellular networks).

The release management system 160 can generate, using a corresponding user requirements, code differences, and an AI model, a detailed release note for a source code modification. The release management system 160 analyzes version control metadata to obtain a user requirement identifier for a modified source code. The version control metadata can include, for example, branch names, commit messages, and pull request details that reference a user requirement associated with the modified source code. The release management system 160 extracts, from the version control metadata, the user requirement identifier for the modified source code. The release management system 160 retrieves, from the user requirements repository 115, a user requirement associated with the extracted user requirement identifier. In some embodiments, the release management system 160 is provided access to the user requirements repository 115 to perform a query for the user requirement using the extracted user requirement identifier. In certain embodiments, the release management system 160 transmits the extracted user requirement identifier to the project management system 110. The project management system 110 then queries the user requirements repository 115 using the provided identifier and retrieves the corresponding user requirement, which is subsequently returned to the release management system 160.

The release management system 160 interfaces with the source code repository 120 to generate visual representations of code changes, such as a code diff, after merge operations. The release management system 160 retrieves commit information from the DAG structure maintained by the source code repository 120. The release management system 160 identifies specific merge commits and extracts the associated branch references. The release management system 160 compares the content of files before and after integration operations, highlighting added, modified, and removed code segments. The release management system 160 formats these differences in a structured output. For example, inserted lines are usually marked with “+”, “+a”, or “a+”, while removed lines are marked with “-”, “-a”, or “a-+”.

The release management system 160 generates a prompt using the user requirement and the code diff. The prompt is then provided to an artificial intelligence (AI) model 165, such as an LLM. The AI model 165 processes the prompt, which includes the user requirement and the code diff, to generate a release note. The release note may include, among other things, release date in production environment, deployment date in test environment, associated sprint or iteration identifier, service change request number, responsible team designation, project name, version number using semantic versioning, summary derived from user requirements, demand tracking number, strategic initiative alignment, categorization label, implemented features list, referenced user requirements, description of new capabilities, details on improvements or optimizations, enumeration of bug fixes, and a comprehensive changelog documenting all modifications since the previous release.

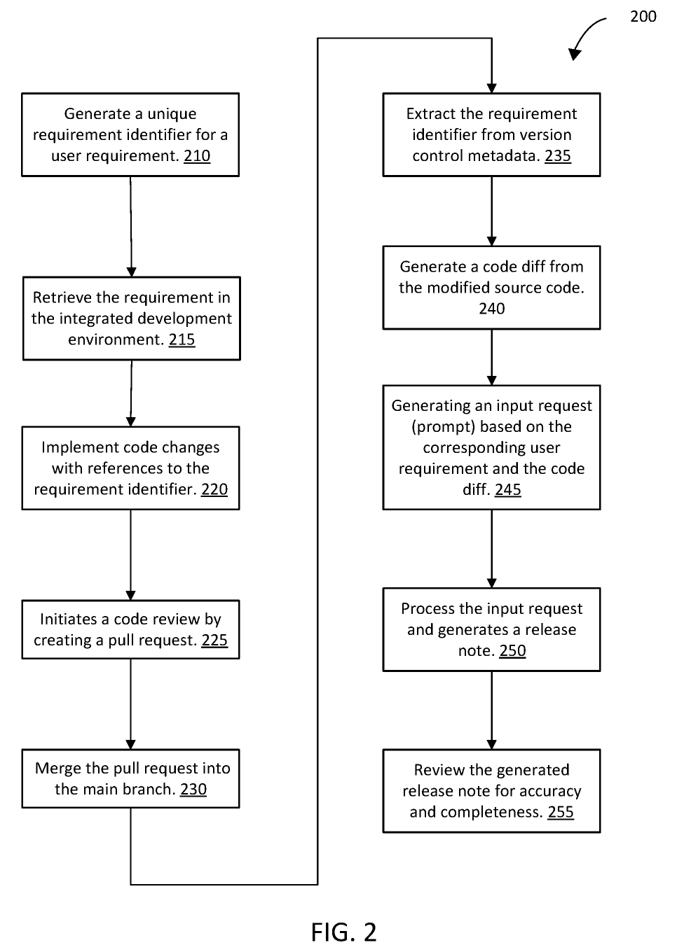

FIG. 2 is a release management workflow 200 according to at least one embodiment. The release management workflow 200 may be performed by processing logic that may comprise hardware (e.g., circuitry, dedicated logic, programmable logic, microcode, etc.), software (e.g., instructions run on a processing device to perform hardware simulation), or a combination thereof. In one embodiment, the release management workflow 200 is performed by a release management system (e.g., release management system 160 of FIG. 1).

At step 210 of the workflow 200, the project management system (e.g., project management system 110 of FIG. 1) generates a unique requirement identifier for the user requirement. This identifier is then propagated to integrated systems for tracking purposes.

At step 215 of the workflow 200, the requirement is retrieved in the integrated development environment (e.g., integrated development environment 140 of FIG. 1), where a developer creates a feature branch in the source code repository (e.g., source code repository 120 of FIG. 1). This branch is named using the unique requirement identifier.

At step 220 of the workflow 200, the developer implements code changes with references to the requirement identifier, making commits in the source code repository and describing each change with the requirement identifier.

At step 225 of the workflow 200, the developer initiates a code review by creating a pull request, which references the original user requirement and includes metadata for tracking. At step 230 of the workflow 200, upon successful review, the pull request is merged into the main branch, and the project management system updates the status of the user requirement to indicate that implementation is complete.

At step 235 of the workflow 200, the release management system (e.g., release management system 160 of FIG. 1) extracts the requirement identifier from version control metadata, such as branch names, commit messages, and pull request details. At step 240 of the workflow 200, the release management system generates a code diff from the modified source code to show the differences between the original and the modified code.

At step 245 of the workflow 200, an input request (prompt) is generated based on the corresponding user requirement and the code diff, which is then provided to the LLM for processing. At step 250, the LLM processes this input request and generates a release note, which includes details such as the release date, deployment date, associated sprint or iteration identifier, features list, and a comprehensive changelog. At step 255 of the workflow 200, the generated release note is reviewed for accuracy and completeness. Any necessary adjustments are made before the final release note is documented and distributed.

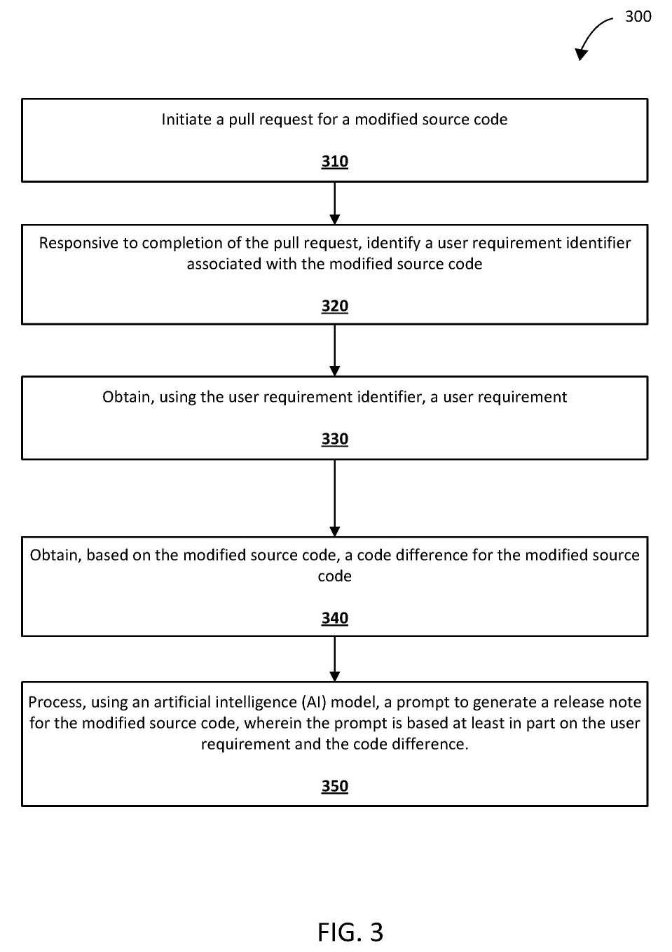

FIG. 3 is a flow diagram of a method 300 of automated release note generation according to at least one embodiment. The method 300 may be performed by processing logic that may comprise hardware (e.g., circuitry, dedicated logic, programmable logic, microcode, etc.), software (e.g., instructions run on a processing device to perform hardware simulation), or a combination thereof. In one embodiment, the method 300 is performed by a release management system (e.g., release management system 160 of FIG. 1).

At block 310, the processing logic initiates a pull request for a modified source code. For example, the modified source code may be for a network function of cellular network. In some embodiments, to initiates the pull request for the modified source code, the processing logic merges the modified source code into a primary branch. The primary branch may contain a main source code.

Responsive to completion of the pull request, at block 320, the processing logic identifies a user requirement identifier associated with the modified source code. In some embodiments, the user requirement identifier may include a branch name of a branch containing the modified source code, a commit message of a commit of the modified source code, or metadata of the pull request.

At block 330, the processing logic obtains, using the user requirement identifier, a user requirement. In some embodiments, to obtain the user requirement, the processing logic queries, using the user requirement identifier, a user requirements repository for the user requirement associated with the user requirement identifier. The user requirements repository may include a plurality of user requirements each assigned a unique user requirement identifier.

At block 340, the processing logic obtains, based on the modified source code, a code difference for the modified source code. In some embodiments, the code difference may represent a difference between the modified source code and a main source code.

At block 350, the processing logic processes, using an artificial intelligence (AI) model, a prompt to generate a release note for the modified source code. The prompt may be based at least in part on the user requirement and the code difference. In some embodiments, the AI model may be one or more LLMs. In some embodiments, the AI model that processes the prompt to generate the release note for the modified source code may be a part of a cellular network.

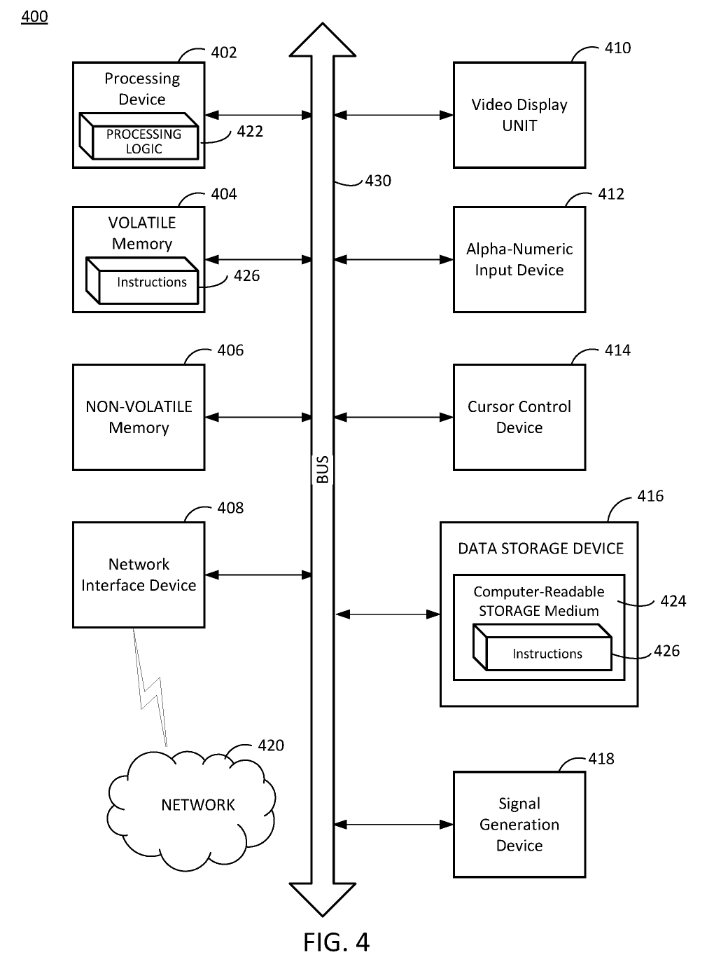

FIG. 4 illustrates a block diagram illustrating an exemplary computer device 400 (or computing device), in accordance with implementations of the present disclosure. Example computer device 400 can be connected to other computer devices in a LAN, an intranet, an extranet, and/or the Internet. Computer device 400 can operate in the capacity of a server in a client-server network environment. Computer device 400 can be a personal computer (PC), a set-top box (STB), a server, a network router, switch or bridge, or any device capable of executing a set of instructions (sequential or otherwise) that specify actions to be taken by that device. Further, while only a single example computer device is illustrated, the term “computer” shall also be taken to include any collection of computers that individually or jointly execute a set (or multiple sets) of instructions to perform any one or more of the methods discussed herein.

Example computer device 400 can include a processing device 402 (also referred to as a processor, CPU, or GPU), a volatile memory 404 (or main memory, e.g., read-only memory (ROM), flash memory, dynamic random access memory (DRAM) such as synchronous DRAM (SDRAM), etc.), a non-volatile memory 406 (e.g., flash memory, static random access memory (SRAM), etc.), and a secondary memory (e.g., a data storage device 416), which can communicate with each other via a bus 430.

Processing device 402 (which can include processing logic 422) represents one or more general-purpose processing devices such as a microprocessor, central processing unit, or the like. More particularly, processing device 402 can be a complex instruction set computing (CISC) microprocessor, reduced instruction set computing (RISC) microprocessor, very long instruction word (VLIW) microprocessor, processor implementing other instruction sets, or processors implementing a combination of instruction sets. Processing device 402 can also be one or more special-purpose processing devices such as an ASIC, a FPGA, a digital signal processor (DSP), network processor, or the like. In accordance with one or more aspects of the present disclosure, processing device 402 can be configured to execute instructions performing the method disclosed herein.

Example computer device 400 can further comprise a network interface device 408, which can be communicatively coupled to a network 420. Example computer device 400 can further comprise a video display 410 (e.g., a liquid crystal display (LCD), a touch screen, or a cathode ray tube (CRT)), an alphanumeric input device 412 (e.g., a keyboard), a cursor control device 414 (e.g., a mouse), and an acoustic signal generation device 418 (e.g., a speaker).

Data storage device 416 can include a computer-readable storage medium (or, more specifically, a non-transitory computer-readable storage medium) 424 on which is stored one or more sets of executable instructions 426. In accordance with one or more aspects of the present disclosure, executable instructions 426 can comprise executable instructions performing the method disclosed herein.

Executable instructions 426 can also reside, completely or at least partially, within volatile memory 404 and/or within processing device 402 during execution thereof by example computer device 400, volatile memory 404 and processing device 402 also constituting computer-readable storage media. Executable instructions 426 can further be transmitted or received over a network via network interface device 408.

While the computer-readable storage medium 424 is shown in FIG. 4 as a single medium, the term “computer-readable storage medium” or “non-transitory computer-readable storage medium storing instructions” or “computer-readable instructions” should be taken to include a single medium or multiple media (e.g., a centralized or distributed database, and/or associated caches and servers) that store the one or more sets of operating instructions. The term “computer-readable storage medium” shall also be taken to include any medium that is capable of storing or encoding a set of instructions for execution by the machine that cause the machine to perform any one or more of the methods described herein. The term “computer-readable storage medium” shall accordingly be taken to include, but not be limited to, solid-state memories, and optical and magnetic media.

Some portions of the detailed descriptions above are presented in terms of algorithms and symbolic representations of operations on data bits within a computer memory. These algorithmic descriptions and representations are the means used by those skilled in the data processing arts to convey the substance of their work most effectively to others skilled in the art. An algorithm is here, and generally, conceived to be a self-consistent sequence of steps leading to a desired result. The steps are those requiring physical manipulations of physical quantities. Usually, though not necessarily, these quantities take the form of electrical or magnetic signals capable of being stored, transferred, combined, compared, and otherwise manipulated. It has proven convenient at times, principally for reasons of common usage, to refer to these signals as bits, values, elements, symbols, characters, terms, numbers, or the like.

It should be borne in mind, however, that all of these and similar terms are to be associated with the appropriate physical quantities and are merely convenient labels applied to these quantities. Unless specifically stated otherwise, as apparent from the following discussion, it is appreciated that throughout the description, discussions utilizing terms such as “initiating,” “identifying,” “obtaining,” “processing,” “merging,” “querying,” or the like, refer to the action and processes of a computer system, or similar electronic computing device, that manipulates and transforms data represented as physical (electronic) quantities within the computer system's registers and memories into other data similarly represented as physical quantities within the computer system memories or registers or other such information storage, transmission or display devices.

Examples of the present disclosure also relate to an apparatus for performing the methods described herein. This apparatus can be specially constructed for the required purposes, or it can be a general-purpose computer system selectively programmed by a computer program stored in the computer system. Such a computer program can be stored in a computer readable storage medium, such as, but not limited to, any type of disk including optical disks, CD-ROMs, and magnetic-optical disks, read-only memories (ROMs), random access memories (RAMs), EPROMs, EEPROMs, magnetic disk storage media, optical storage media, flash memory devices, other type of machine-accessible storage media, or any type of media suitable for storing electronic instructions, each coupled to a computer system bus.

The methods and displays presented herein are not inherently related to any particular computer or other apparatus. Various general-purpose systems can be used with programs in accordance with the teachings herein, or it may prove convenient to construct a more specialized apparatus to perform the required method steps. The required structure for a variety of these systems will appear as set forth in the description below. In addition, the scope of the present disclosure is not limited to any particular programming language. It will be appreciated that a variety of programming languages can be used to implement the teachings of the present disclosure.

It is to be understood that the above description is intended to be illustrative, and not restrictive. Many other implementation examples will be apparent to those of skill in the art upon reading and understanding the above description. Although the present disclosure describes specific examples, it will be recognized that the systems and methods of the present disclosure are not limited to the examples described herein, but can be practiced with modifications within the scope of the appended claims. Accordingly, the specification and drawings are to be regarded in an illustrative sense rather than a restrictive sense. The scope of the present disclosure should, therefore, be determined with reference to the appended claims, along with the full scope of equivalents to which such claims are entitled.

Other variations are within the scope of the present disclosure. Thus, while disclosed techniques are susceptible to various modifications and alternative constructions, certain illustrated embodiments thereof are shown in drawings and have been described above in detail. It should be understood, however, that there is no intention to limit the disclosure to a specific form or forms disclosed, but on the contrary, the intention is to cover all modifications, alternative constructions, and equivalents falling within the spirit and scope of the disclosure, as defined in appended claims.

Use of terms “a” and “an” and “the” and similar referents in the context of describing disclosed embodiments (especially in the context of following claims) are to be construed to cover both singular and plural, unless otherwise indicated herein or clearly contradicted by context, and not as a definition of a term. Terms “comprising,” “having,” “including,” and “containing” are to be construed as open-ended terms (meaning “including, but not limited to,”) unless otherwise noted. “Connected,” when unmodified and referring to physical connections, is to be construed as partly or wholly contained within, attached to, or joined together, even if there is something intervening. Recitations of ranges of values herein are merely intended to serve as a shorthand method of referring individually to each separate value falling within the range, unless otherwise indicated herein, and each separate value is incorporated into the specification as if it were individually recited herein. In at least one embodiment, the use of the term “set” (e.g., “a set of items”) or “subset” unless otherwise noted or contradicted by context, is to be construed as a nonempty collection comprising one or more members. Further, unless otherwise noted or contradicted by context, the term “subset” of a corresponding set does not necessarily denote a proper subset of the corresponding set, but subset and corresponding set may be equal.

Conjunctive language, such as phrases of the form “at least one of A, B, and C,” or “at least one of A, B and C,” unless specifically stated otherwise or otherwise clearly contradicted by context, is otherwise understood with the context as used in general to present that an item, term, etc., may be either A or B or C, or any nonempty subset of the set of A and B and C. For instance, in an illustrative example of a set having three members, conjunctive phrases “at least one of A, B, and C” and “at least one of A, B and C” refer to any of the following sets: {A}, {B}, {C}, {A, B}, {A, C}, {B, C}, {A, B, C}. Thus, such conjunctive language is not generally intended to imply that certain embodiments require at least one of A, at least one of B and at least one of C each to be present. In addition, unless otherwise noted or contradicted by context, the term “plurality” indicates a state of being plural (e.g., “a plurality of items” indicates multiple items). In at least one embodiment, the number of items in a plurality is at least two, but can be more when so indicated either explicitly or by context. Further, unless stated otherwise or otherwise clear from context, the phrase “based on” means “based at least in part on” and not “based solely on.”

Operations of processes described herein can be performed in any suitable order unless otherwise indicated herein or otherwise clearly contradicted by context. In at least one embodiment, a process such as those processes described herein (or variations and/or combinations thereof) is performed under control of one or more computer systems configured with executable instructions and is implemented as code (e.g., executable instructions, one or more computer programs or one or more applications) executing collectively on one or more processors, by hardware or combinations thereof. In at least one embodiment, code is stored on a computer-readable storage medium, for example, in the form of a computer program comprising a plurality of instructions executable by one or more processors. In at least one embodiment, a computer-readable storage medium is a non-transitory computer-readable storage medium that excludes transitory signals (e.g., a propagating transient electric or electromagnetic transmission) but includes non-transitory data storage circuitry (e.g., buffers, cache, and queues) within transceivers of transitory signals. In at least one embodiment, code (e.g., executable code or source code) is stored on a set of one or more non-transitory computer-readable storage media having stored thereon executable instructions (or other memory to store executable instructions) that, when executed (i.e., as a result of being executed) by one or more processors of a computer system, cause a computer system to perform operations described herein. In at least one embodiment, a set of non-transitory computer-readable storage media comprises multiple non-transitory computer-readable storage media and one or more of individual non-transitory storage media of multiple non-transitory computer-readable storage media lack all of the code while multiple non-transitory computer-readable storage media collectively store all of the code. In at least one embodiment, executable instructions are executed such that different instructions are executed by different processors.

Accordingly, in at least one embodiment, computer systems are configured to implement one or more services that singly or collectively perform operations of processes described herein, and such computer systems are configured with applicable hardware and/or software that enable the performance of operations. Further, a computer system that implements at least one embodiment of present disclosure is a single device and, in another embodiment, is a distributed computer system comprising multiple devices that operate differently such that distributed computer system performs operations described herein and such that a single device does not perform all operations.

Use of any and all examples, or exemplary language (e.g., “such as”) provided herein, is intended merely to better illuminate embodiments of the disclosure and does not pose a limitation on the scope of the disclosure unless otherwise claimed. No language in the specification should be construed as indicating any non-claimed element as essential to the practice of the disclosure.

All references, including publications, patent applications, and patents, cited herein are hereby incorporated by reference to the same extent as if each reference were individually and specifically indicated to be incorporated by reference and were set forth in its entirety herein.

In description and claims, the terms “coupled” and “connected,” along with their derivatives, may be used. It should be understood that these terms may not be intended as synonyms for each other. Rather, in particular examples, “connected” or “coupled” may be used to indicate that two or more elements are in direct or indirect physical or electrical contact with each other. “Coupled” may also mean that two or more elements are not in direct contact with each other, but yet still co-operate or interact with each other.

Unless specifically stated otherwise, it may be appreciated that throughout specification terms such as “processing,” “computing,” “calculating,” “determining,” or like, refer to actions and/or processes of a computer or computing system, or similar electronic computing device, that manipulate and/or transform data represented as physical, such as electronic, quantities within computing system’s registers and/or memories into other data similarly represented as physical quantities within computing system’s memories, registers or other such information storage, transmission or display devices.

In a similar manner, the term “processor” may refer to any device or portion of a device that processes electronic data from registers and/or memory and transform that electronic data into other electronic data that may be stored in registers and/or memory. As non-limiting examples, a “processor” may be a network device or a MACsec device. A “computing platform” may comprise one or more processors. As used herein, “software” processes may include, for example, software and/or hardware entities that perform work over time, such as tasks, threads, and intelligent agents. Also, each process may refer to multiple processes, for carrying out instructions in sequence or in parallel, continuously or intermittently. In at least one embodiment, the terms “system” and “method” are used herein interchangeably insofar as the system may embody one or more methods, and methods may be considered a system.

In the present document, references may be made to obtaining, acquiring, receiving, or inputting analog or digital data into a sub-system, computer system, or computer-implemented machine. In at least one embodiment, the process of obtaining, acquiring, receiving, or inputting analog and digital data can be accomplished in a variety of ways, such as by receiving data as a parameter of a function call or a call to an application programming interface. In at least one embodiment, processes of obtaining, acquiring, receiving, or inputting analog or digital data can be accomplished by transferring data via a serial or parallel interface. In at least one embodiment, processes of obtaining, acquiring, receiving, or inputting analog or digital data can be accomplished by transferring data via a computer network from providing entity to acquiring entity. In at least one embodiment, references may also be made to providing, outputting, transmitting, sending, or presenting analog or digital data. In various examples, processes of providing, outputting, transmitting, sending, or presenting analog or digital data can be accomplished by transferring data as an input or output parameter of a function call, a parameter of an application programming interface, or an inter-process communication mechanism.

Although descriptions herein set forth example embodiments of described techniques, other architectures may be used to implement described functionality, and are intended to be within the scope of this disclosure. Furthermore, although specific distributions of responsibilities may be defined above for purposes of description, various functions and responsibilities might be distributed and divided in different ways, depending on circumstances.

Furthermore, although the subject matter has been described in language specific to structural features and/or methodological acts, it is to be understood that the subject matter claimed in appended claims is not necessarily limited to specific features or acts described. Rather, specific features and acts are disclosed as exemplary forms of implementing the claims.

What is claimed is:

1. A method comprising:
initiating a pull request for a modified source code;
responsive to completion of the pull request, identifying a user requirement identifier associated with the modified source code;
obtaining, using the user requirement identifier, a user requirement;
obtaining, based on the modified source code, a code difference for the modified source code; and
processing, using an artificial intelligence (AI) model, a prompt to generate a release note for the modified source code, wherein the prompt is based at least in part on the user requirement and the code difference.

2. The method of claim 1, wherein initiating the pull request for the modified source code comprises:
merging the modified source code into a primary branch, wherein the primary branch contains a main source code.

3. The method of claim 1, wherein obtaining, using the user requirement identifier, the user requirement comprises:
querying, using the user requirement identifier, a repository for the user requirement associated with the user requirement identifier, wherein the repository includes a plurality of user requirements each assigned a unique user requirement identifier.

4. The method of claim 1, wherein the code difference represents a difference between the modified source code and a main source code of the primary branch.

5. The method of claim 1, wherein the AI model comprises one or more large language models (LLMs).

6. The method of claim 1, wherein the user requirement identifier is included in at least one of: a branch name of a branch containing the modified source code, a commit message of a commit of the modified source code, or metadata of the pull request.

7. The method of claim 1, wherein the AI model that processes the prompt to generate the release note for the modified source code is part of a network function of a cellular network.

8. A system comprising:
a processing device to perform operations comprising:
initiating a pull request for a modified source code;
responsive to completion of the pull request, identifying a user requirement identifier associated with the modified source code;
obtaining, using the user requirement identifier, a user requirement;
obtaining, based on the modified source code, a code difference for the modified source code; and
processing, using an artificial intelligence (AI) model, a prompt to generate a release note for the modified source code, wherein the prompt is based at least in part on the user requirement and the code difference.

9. The system of claim 8, wherein initiating the pull request for the modified source code comprises:
merging the modified source code into a primary branch, wherein the primary branch contains a main source code.

10. The system of claim 8, wherein obtaining, using the user requirement identifier, the user requirement comprises:
querying, using the user requirement identifier, a repository for the user requirement associated with the user requirement identifier, wherein the repository includes a plurality of user requirements each assigned a unique user requirement identifier.

11. The system of claim 8, wherein the code difference represents a difference between the modified source code and a main source code of the primary branch.

12. The system of claim 8, wherein the AI model comprises one or more large language models (LLMs).

13. The system of claim 8, wherein the user requirement identifier is included in at least one of: a branch name of a branch containing the modified source code, a commit message of a commit of the modified source code, or metadata of the pull request.

14. The system of claim 8, wherein the AI model that processes the prompt to generate the release note for the modified source code is part of a network function of a cellular network.

15. A non-transitory computer-readable storage medium comprising instructions that, when executed by a processing device, cause the processing device to perform operations comprising:
initiating a pull request for a modified source code;
responsive to completion of the pull request, identifying a user requirement identifier associated with the modified source code;
obtaining, using the user requirement identifier, a user requirement;
obtaining, based on the modified source code, a code difference for the modified source code; and
processing, using an artificial intelligence (AI) model, a prompt to generate a release note for the modified source code, wherein the prompt is based at least in part on the user requirement and the code difference.

16. The non-transitory computer-readable storage medium of claim 15, wherein initiating the pull request for the modified source code comprises:
merging the modified source code into a primary branch, wherein the primary branch contains a main source code.

17. The non-transitory computer-readable storage medium of claim 15, wherein obtaining, using the user requirement identifier, the user requirement comprises:
querying, using the user requirement identifier, a repository for the user requirement associated with the user requirement identifier, wherein the repository includes a plurality of user requirements each assigned a unique user requirement identifier.

18. The non-transitory computer-readable storage medium of claim 15, wherein the code difference represents a difference between the modified source code and a main source code of the primary branch.

19. The non-transitory computer-readable storage medium of claim 15, wherein the AI model comprises one or more large language models (LLMs).

20. The non-transitory computer-readable storage medium of claim 15, wherein the user requirement identifier is included in at least one of: a branch name of a branch containing the modified source code, a commit message of a commit of the modified source code, or metadata of the pull request.
